(19) United States
(12) Patent Application Publication
(10) Pub. No.: US 2021/0168306 A1
(43) Pub. Date: Jun. 3, 2021

(54) Nfrared Projector, Imaging Device, and Terminal Device

(71) Applicant: Guangdong Oppo Mobile Telecommunications Corp., Ltd., Dongguan (CN)

(72) Inventors: Yuan Lin, Palo Alto, CA (US); Chiuman Ho, Palo Alto, CA (US)

(21) Appl. No.: 17/176,815

(22) Filed: Feb. 16, 2021

Related U.S. Application Data
(63) Continuation of application No. PCT/CN2019/102062, filed on Aug. 22, 2019.
(60) Provisional application No. 62/722,769, filed on Aug. 24, 2018.

(51) Int. Cl. H04N 5/33; G02B 27/42; G02B 7/182; H04N 13/254

(52) U.S. Cl. CPC H04N 5/33; H04N 13/254; G02B 7/182; G02B 27/4205

(57) ABSTRACT

An infrared projector, an imaging device, and a terminal device are provided. The infrared projector provided herein includes an infrared source, a light reflective section, a light filtering section, and at least one driving component. The infrared source is configured to emit infrared light. The light reflective section is configured to receive and reflect the infrared light from the infrared source. The light filtering section is configured to receive the infrared light reflected by the light reflective section. The at least one driving component is configured to drive at least one of the light reflective section and the light filtering section to move.

### CROSS-REFERENCE TO RELATED APPLICATION(S)

The present disclosure is a continuation-application of International (PCT) Patent Application No. PCT/CN2019/102062 filed Aug. 22, 2019, which claims priority of U.S. Provisional Patent Application No. 62/722,769, filed on Aug. 24, 2018, the entire contents of all of which are hereby incorporated by reference.

### TECHNICAL FIELD

This disclosure relates to the field of optical technology, and particularly to an infrared projector, an imaging device, and a terminal device.

### BACKGROUND

With the recent advancements of the hardware and algorithms, a depth camera is now small enough to be integrated into a portable device such as a smart phone (e.g., iPhone X and OPPO Find X). With the depth camera, many applications have been developed, such as Face ID, virtual reality (VR), augmented reality (AR), gesture control, 3D measurement, and Animoji® (iOS includes an animated emoji feature known as Animoji), etc. These commercial applications drive the needs for more accurate and higher resolution 3D shape measurement techniques.

### SUMMARY

Disclosed herein are implementations of an infrared projector, an imaging device, and a terminal device.

The infrared projector provided herein includes an infrared source, a light reflective section, a light filtering section, and at least one driving component. The infrared source is configured to emit infrared light. The light reflective section is configured to receive and reflect the infrared light from the infrared source. The light filtering section is configured to receive the infrared light reflected by the light reflective section. The at least one driving component is configured to drive at least one of the light reflective section and the light filtering section to move.

The imaging device provided herein includes an infrared projector and an infrared camera. The infrared projector includes an infrared source, a light reflective section, a light filtering section, and at least one driving component. The infrared camera is configured to emit infrared light. The light reflective section is configured to receive and reflect the infrared light emitted from the infrared source. The light filtering section is configured receive the infrared light reflected by the light reflective component and let the infrared light pass through to be projected on an object to form point cloud. The at least one driving component is disposed in at least one of the light reflective section and the light filtering section and configured to change a light path from the light reflective section to the object. The infrared camera is configured to capture an image of the project according to the point cloud.

The terminal device provided herein includes an infrared projector, an infrared camera, and a housing for accommodate the infrared projector and the infrared camera. The infrared projector includes an infrared source, a light reflective section, a light filtering section, and at least one driving component. The infrared source is configured to emit infrared light. The light reflective section is configured to receive and reflect the infrared light emitted from the infrared source. The light filtering section is configured receive the infrared light reflected by the light reflective component and let the infrared light pass through to be projected on an object to form point cloud. The at least one driving component is disposed in at least one of the light reflective section and the light filtering section and configured to change a light path from the light reflective section to the object. The infrared camera is configured to capture an image of the project according to the point cloud.

### BRIEF DESCRIPTION OF DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is schematic diagram illustrating an exemplary image of infrared point cloud projected from the dot projector onto a face.

FIG. 2 is a schematic block diagram illustrating a terminal device.

FIG. 3 is a block diagram illustrating the terminal device.

FIG. 4 is a block diagram illustrating a traditional 3D imaging device.

FIG. 5 is a block diagram illustrating an infrared projector according to an embodiment of the disclosure.

FIG. 6 and FIG. 7 are schematic diagrams illustrating light transmission in the infrared projector.

FIG. 8 is a schematic diagram illustrating the infrared projector in which a driving component is disposed at a light reflective section.

FIG. 9 is another schematic diagram illustrating light transmission in the infrared projector.

FIG. 10 a schematic diagram illustrating a scheme using a micro-mirror actuator.

FIG. 11 is a schematic diagram illustrating a micro-mirror actuator.

FIG. 12 is a schematic block diagram illustrating the infrared projector in which a driving component is disposed at a light filtering section.

FIG. 13 is a schematic diagram illustrating a principle of operation of a diffractive optical element.

FIG. 14 is another schematic block diagram illustrating the infrared projector in which a driving component is disposed at a light filtering section.

FIG. 15 is a schematic diagram illustrating an actuator.

FIG. 16 is a schematic effect diagram illustrating infrared dots in point cloud when a mask is mounted on an actuator.

FIG. 17 is a schematic effect diagram illustrating infrared dots in point cloud when a mask is mounted on two actuators.

FIG. 18 and FIG. 19 are schematic block diagrams illustrating an imaging device according to an embodiment of the disclosure.

FIG. 20 is a block diagram illustrating a terminal device according to an embodiment of the disclosure.

### DETAILED DESCRIPTION

Embodiments of the disclosure will now be described in detail with reference to the accompanying figures. Like elements in the various figures are denote by like reference numerals for consistency.

Initially, abbreviation and definition of key terms are given below to facilitate the understanding of the disclosure.

Super resolution imaging: Super resolution imaging is a class of techniques that enhance the resolution and exceed the resolution limit of an imaging system and acquire higher and more accurate resolution depth information. Super resolution imaging techniques are used in general image processing and in super-resolution microscopy.

3D measurement: 3D measurement is a technique that can scan the 3D shape and the depth information of objects in a scene.

3D sensor: 3D sensor, also known as 3D scanner, is a device that analyses a real-world object or environment to collect data on its shape and possibly its appearance (e.g. color). The collected data can then be used to construct digital three-dimensional models. The purpose of a 3D sensor is usually to create a 3D model. This 3D model consists of a point cloud of geometric samples on the surface of the subject. These points can then be used to extrapolate the shape of the subject (a process called reconstruction). If color information is collected at each point, then the colors on the surface of the subject can also be determined.

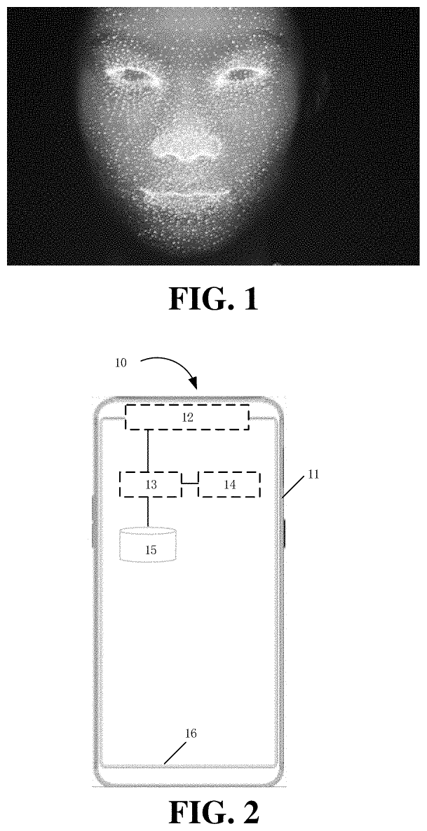

Point cloud: point cloud is a set of data points in space. Point clouds are generally produced by 3D scanners, which measure a large number of points on the external surfaces of objects around them. As the output of 3D scanning processes, point clouds are used for many purposes, including to create 3D CAD models for manufactured parts, for metrology and quality inspection, and for a multitude of visualization, animation, rendering and mass customization applications. FIG. 1 is schematic diagram illustrating an exemplary image of infrared point cloud projected from an infrared projector (also known as dot projector) onto a face.

In order to obtain the depth information of images, many manufacturers have carried out research and development in recent years. At present, there are two mature technologies, that is, time of flight (TOF) and structured light.

TOF: this technology emits infrared light using a light emitting diode (LED) or a laser diode (LD), and the infrared light illuminates the surface of the object and then reflects back. Since the speed of light (v) is known, an infrared light image sensor can be used to measure the reflection time (t) of positions at different depths of the object, and the distance (depth) of different positions of the object can be calculated by a simple mathematical formula.

Structured light: this technology uses a laser diode or a digital light processor (DLP) to produce different light patterns, which are reflected by different depths of the object and cause distortion of the light patterns. For example, when the light of the straight stripe is irradiated onto a finger, since the finger is a three-dimensional arc shape, the straight line stripe is reflected back to become an arc-shaped stripe. After the arc-shaped stripe enters the infrared image sensor, the three-dimensional structure of the finger can be derived by using the arc-shaped stripe.

In the related art, depth maps captured with TOF cameras have very low data quality: the image resolution is rather limited and the level of random noise contained in the depth maps is very high. Considering this, Schuon S, et al. present LidarBoost, a 3D depth super-resolution method that combines several low-resolution noisy depth images of a static scene from slightly displaced viewpoints, and merges them into a high-resolution depth image.

The drawback of LidarBoost is that it can only be applied to static scenes, and cannot be used to non-static scenes, such as scanning a smiling user.

In US patent application U.S. Ser. No. 14/322,887 of Texas Instruments Inc, a super-resolution in structured light imaging is provided. This 887' case, however, limits the depth camera to the “structured light” technique. Moreover, the 887' case only considers one way of shifting the projected patterns, i.e., shifting the camera and therefore, is not flexible enough. In addition, the 887' case does not consider the device size constraint on portable devices.

In view of this, we propose technical solutions that can take high-resolution depth images with super-resolution dynamic scenes. The disclosure provides a super-resolution technique for depth cameras, which can acquire a high-resolution depth image by combining a plurality of images of a scene. Particularly, in addition to static scenes, the super-resolution technique provided herein can be applied to non-static scenes such as scanning a smiling user, and there is no need to shift the camera to shift projected patterns (point cloud) on an object such as a user face. A product implementing the technical solutions can be easily integrated into a smart phone is also provided due to small device size.

The following aspects of the disclosure contribute to its advantages and each will be described in detail below.

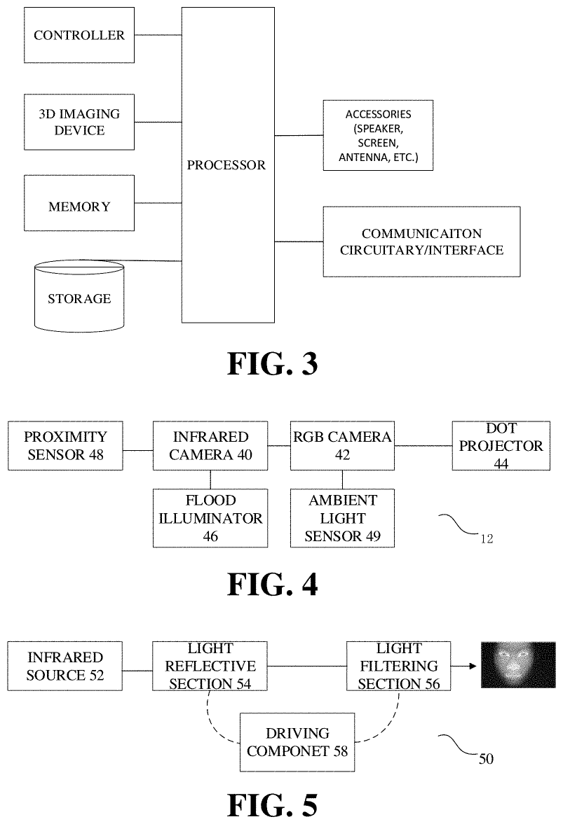

FIG. 2 and is a schematic block diagram illustrating a terminal device. FIG. 3 is a block diagram illustrating a traditional imaging device. As illustrated in FIG. 2 and FIG. 3, the terminal device 10 includes a housing 11 and a screen 16 as well as other accessories such as a speaker, an antenna, and the like. The housing 11 is configured to accommodate internal components of the terminal device 10, such as those described below. The terminal device 10 further includes a 3D imaging device 12, at least one processor 13 (only one processor, such as a main processor, is illustrated in FIG. 3 for ease of explanation), a memory 14, and storage 15. The 3D imaging device 12 is generally disposed on the top of the terminal device and is coupled with the at least one processor 13. The at least one processor 13 is coupled with and has access to the memory 14 and a storage 15. As illustrated in FIG. 3, the terminal device may further comprises a controller, which acts as a core control center of the terminal device 10 and is coupled with the at least one processor 13. As one example, the images or data obtained via the 3D imaging device 12 can be provided to the at least one processor 13 for further processing or can be stored in the storage 15. The storage 15 is configured to store lock/unlock applications and images, pictures of users, and the like. For example, the at least one processor 13 (such as an application processing unit (APU)) can analyze and process the data or image obtained by the 3D imaging device 12 and control operations of the terminal device 10 according to the processing result. In case of face recognition for unlocking, the 3D imaging device 12 may capture a facial image of a user and provide the facial image to the at least one processor 13, whereby the at least one processor 13 can compare the facial image with a preset facial image template to determine whether the user is a legal or registered user of the terminal. If the facial image matches with the facial image template, it indicates that the facial recognition is successful and the screen 16 of the terminal device 10 can be unlocked.

The terminal device 10 may further include a fingerprint senor for fingerprint recognition.

FIG. 4 is schematic diagram illustrating a traditional 3D imaging device. The 3D imaging device can be comprehended as a 3D shape measurement device, which includes multiple cameras and a depth sensor(s). The 3D imaging device illustrated in FIG. 4 includes an infrared camera 40, a RGB camera 42, and a dot projector 44. The infrared camera 40, the RGB camera 42, and the dot projector 44 can be integrated into one module. The dot projector 44 is also known as a dot-pattern illuminator and is configured to project infrared light dots (that is, point cloud) on a project to be scanned.

The 3D imaging device may further include a flood illuminator 46 and sensors, such as a proximity sensor 48 and an ambient light sensor 49. The flood illuminator 46 and the proximity sensor 48 can be integrated into one module.

The device of FIG. 4 can be structured to be able to achieve 3D shape scanning, imaging, face recognition, and the like. In the following, face recognition is introduced as an example.

When an object is close to a mobile phone equipped with the 3D imaging device, for example, the proximity sensor 48 or any other structured light sensor will be launched first to determine whether there is face information. Once it is determined that there is face information, the dot projector 44 will be started to project about more than 30,000 infrared light points on the user face to form point cloud illustrated in FIG. 1 for example. The infrared camera 40 will read the point cloud and capture 3D face image to extract the image information of the face. The image captured by the infrared camera 40 is sent to an application processing unit (APU). The APU is configured such that it can conduct face recognition via a trained neural network, according to the 3D images received.

Generally, the resolution of the 3D imaging device depends on several factors, such as the density of the point cloud generated by the dot projector, the resolution of an IR camera, and the distance between the 3D imaging device and the scanned object. The natural way to increase the imaging resolution is increasing the density of the point cloud, such that more sampling points can be obtained. At the same time, the resolution of the infrared camera also needs to be increased to identify these points. Here, we provide a different way to increase the resolution of the 3D image device with actuating or driving mechanism. With aid of the technical solutions provided herein, it is possible to achieve super-resolution results without increasing the resolutions of the point cloud and IR camera.

According to implementations of the disclosure, an infrared projector is provided. FIG. 5 is a block diagram illustrating an infrared projector 50. As illustrated in FIG. 5, the infrared projector 50 includes an infrared source 52, a light reflective section 54, a light filtering section 56, and at least one driving component 58. For example, the infrared projector 50 can be used as the dot projector 44 of FIG. 4.

The infrared source 52 is configured to emit infrared light. The light reflective section 54 is configured to receive and reflect the infrared light from the infrared source 52. The light filtering section 56 is an optical element and is configured to receive the infrared light reflected by the light reflective section 54. For example, the purpose of this light filtering section is to convert the infrared to a structured light or point cloud. The at least one driving component 58 is configured to drive at least one of the light reflective section 54 and the light filtering section 56 to move. For example, the at least one driving component 58 may be coupled with the light reflective section 54, coupled with the light filtering section 56, or coupled with both the light reflective section 54 and the light filtering section 56. The term “couple” used herein can be comprehended as direct connection, attachment, and the like. In order to save internal space of the infrared projector, the driving component(s) 58 can be attached to or bound with the light reflective section 54 and/or the light filtering section 56. As used in the context, the term “at least one of A and B” means A, B, or both A and B, the terminal “A and/or B” means A, B, or both A and B. With such principle in mind, one of ordinary skill in the art may understand that by expressing as “at least one driving component 58 is configured to drive at least one of the light reflective section 54 and the light filtering section 56 to move”, it means that the at least one driving component 58 may be configured to drive the light reflective section 54 to move, drive the light filtering section 56 to move, or drive both the light reflective section 54 and the light filtering section 56 to move. In case multiple components are included in the light reflective section 54, as will be detailed below, the at least one driving component 58 may be configured to drive all or part of the components of the light reflective section 54 to move. In order to drive multiple components of the light reflective section 54 to move, sometimes, multiple driving components 58 will be needed accordingly. The term “move” used herein should be broadly interpreted, for example, it may be exchanged with the term “vibrate”, “shift”, and the like, and may refer to “move in vertical direction”, “move in horizontal direction”, “move or rotate axially” and other motions which can change the incidence angle or exit angle of infrared light, or change the light path or transmission direction of infrared light. The disclosure it not particularly limited.

In one implementation, the at least one driving component 58 is structured such that the light reflective section 54 can be driven to move.

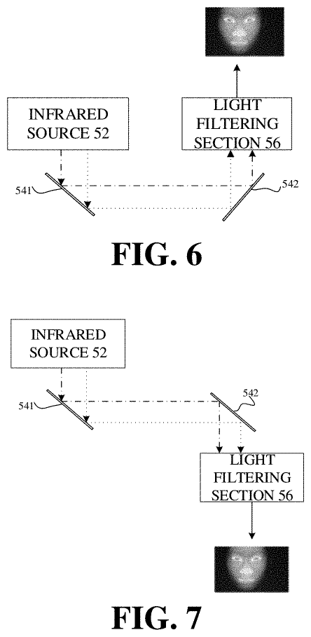

In one implementation, as illustrated in FIG. 6 and FIG. 7, the light reflective section 54 includes functionality to achieve light reflection. For example, the light reflective section 54 includes a first reflective component 541 and a second reflective component 542. The first reflective component 541 is configured to receive and reflect the infrared light from the infrared source 52, and the second reflective component 542 is configured to receive the infrared light from the first reflective component 541 and then reflect the infrared light received from the first reflective component 541 to the light filtering section 56.

As to the position relationship between the first reflective component 541 and the second reflective component 542, the present disclosure is not particularly limited. For example, the first reflective component 541 and the second reflective component 542 can be arranged horizontally such that one component is next to the other. As illustrated in FIG. 6, the first reflective component 541 and the second reflective component 542 may be arranged such that the transmission direction of incident infrared light emitted from the infrared source 52 is opposite to that of the infrared light received by the light filtering section 56. In this case, from another perspective, as illustrated in FIG. 6, the infrared source 52 and the light filtering section 56 are arranged on the same side of the light reflective section 54. Alternatively, as illustrated in FIG. 7, the first reflective component 541 and the second reflective component 542 may be arranged such that the transmission direction of incident infrared light emitted from the infrared source 52 is the same as that of the infrared light received by the light filtering section 56. As can be seen from FIG. 7, the infrared source 52 is arranged opposite to the light filtering section 56 in relative to the light reflective section 54. In other words, the infrared source 52 and the light filtering section 56 are arranged on different sides of the light reflective section 54.

The first reflective component 541 and the second reflective component 542 can be a reflective mirror, reflective plate, or other means with light reflective functions. In the following, take mirror as an example of the reflective component for illustrative purpose only, without any intent to restrict the disclosure.

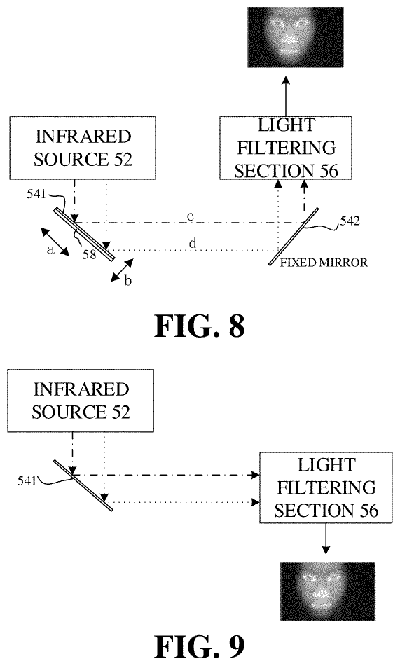

As can be seen from FIG. 8, the driving component 58 can be coupled or attached to the first reflective component 541. Then when the driving component 58 drives the first reflective component to move (such as vibrate, shift, rotate, and the like) along the long edge of the driving component 58 as indicated by the bi-directional arrow as illustrated in FIG. 8 or along the short edge of the driving component 58 as indicated by the bi-directional arrow b illustrated in FIG. 8 or along any other possible directions, the light will be transmitted in a direction different than that illustrated in FIG. 8 with the dotted lines c and d. Thus, at the light filtering section 56, light transmitted in different directions will be projected to an object such as a human face, to form different point cloud. Thus, compared with FIG. 6 where no driving component is provided, more effective reference points on the human face can be obtained. In the case of FIG. 8, the second reflective component 542 is embodied as a fixed mirror.

Similarly, the driving component 58 can be disposed at the second reflective component 542 rather than the first reflective component 541 and in this case, the first reflective component 541 can be configured as a fixed mirror.

Alternatively, even not illustrated in the figures, two driving components 58 may be used to further enhance the actuating effect. For example, one driving components 58 is attached to the first reflective component 541 and the other driving component 58 is attached to the second reflective component 542.

Still another example, different from the structures of FIG. 6 and FIG. 7, as illustrated in FIG. 9, the light reflective section 54 may be implemented with only one reflective component 541. Here, the driving component 58 can be attached to the reflective component 541 to drive the reflective component 541 to move. Person skilled in the art shall comprehend that according to actual needs, other components may also be disposed at the reflective section either, such that the infrared light emitted from the IR source can be transmitted along a predetermined direction to shift the infrared light emitted out at the light filtering section 56.

The foregoing driving component 58 can be implemented with an actuator for example, one example of the actuator is illustrated in FIG. 15, which will be detailed below. The required drive forces for the driving component movement can be provided by various physical principles. In practice, the relevant principles for driving such driving component include but not limited to the electromagnetic, electrostatic, thermo-electric and piezo-electric effects. Because the physical principles differ in their advantages and disadvantages, a suitable driving principle should be chosen according to the application. Since the structure only needs slightly more energy for the movements of the actuators, compared with the related art, approximately the same energy will be consumed and no significant additional power consumption will be induced. Energy consumption may not be an issue.

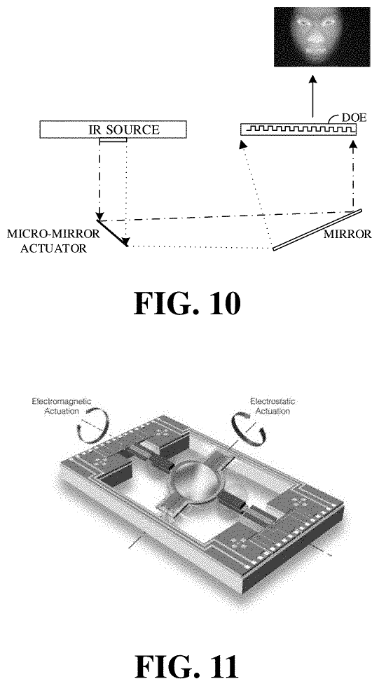

FIG. 10 illustrates an example where a micro-mirror actuator is used in the reflective section. In addition to the foregoing structures in which the driving component 58 is connected to or attached to the light reflective component 541 and/or the light reflective component 542, the driving component 58 and the light reflective component can be integrally formed into one component, such as an actuator with a mirror mounted thereon (hereinafter referred to as “micro-mirror actuator” for short), which is also known as a micro-scanner, micro scanning mirror, micro-electromechanical system (MEMS) mirror, and the like, and is frequently used for dynamical light modulation. The micro-mirror actuator can be employed herein is illustrated in FIG. 11. The micro-mirror actuator can accurately change the orientation angles of the mirror thereof with high frequency, and the direction of the infrared light emitted out of the light filtering section such as a DOE module will be changed accordingly. The required drive forces for the movement of the mirror of the actuator can be provided by various physical principles. In practice, the relevant principles for driving such a mirror are the electromagnetic, electrostatic, thermo-electric and piezo-electric effects. Because the physical principles differ in their advantages and disadvantages, a suitable driving principle should be chosen according to the application.

The advantages of a micro-mirror actuator are based upon their small size, low weight, and minimum power consumption. Further advantages arise along with the integration possibilities. For example, small size of micro-mirror actuator can be disposed close to the infrared source. In addition, with aid of the micro-mirror actuator, the optical path is folded into a small space and it can be easily integrated into a smart phone.

Besides, even each technical solution provided herein with its own advantages, compared with other solutions provided herein, under circumstances of fast resonant conditions, it is feasible and beneficial to use micro-mirror actuator in fast resonant condition for high-frequency scan to resist to the inertia of the infrared projector.

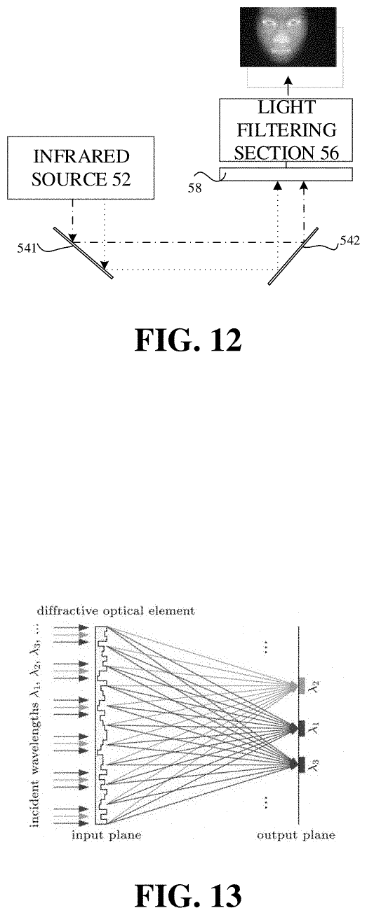

The foregoing depicts situations where the driving component 58 is configured to drive the light reflective section 54 to move. In addition to the above identified structure or alternatively, the driving component 58 is configured to drive the light filtering section 56 to move. As illustrated in FIG. 12, the driving component 58 is coupled with the light filtering section 56. For example, the driving component 58 can be attached to the lower side of the light filtering section 56. In other words, the light filtering section 56 can be mounted on the driving component 58.

The light filtering section 56 can be a diffractive optical element (DOE) or a mask with evenly or unevenly distributed small light through holes. FIG. 13 is a schematic diagram illustrating the operation principle of the DOE. FIG. 13 will be referenced to outline how the DOE works. As illustrated in FIG. 13, incident lights with different wavelengths are incident on an input plane of the DOE, and after manipulating light by diffraction, light points can be formed at the output plane of the DOE.

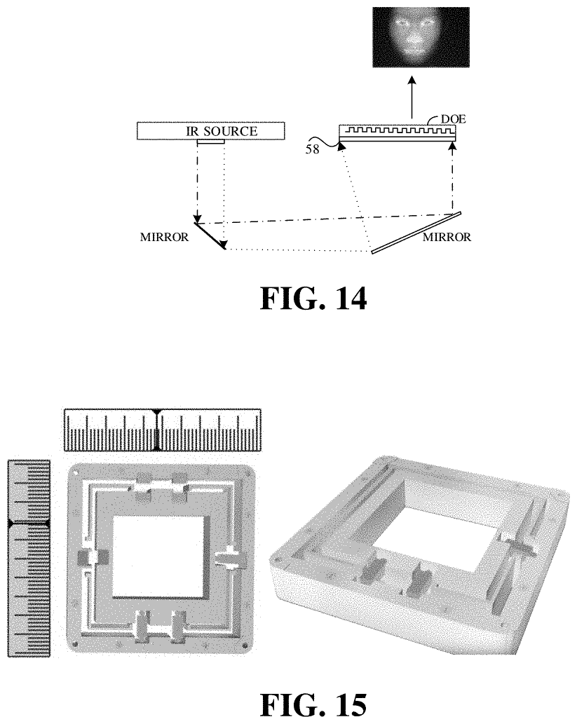

Based on this, FIG. 14 illustrates an example where the driving component 58 such as an actuator is coupled to the DOE. For example, the DOE can be mounted on the actuator. Here, the actuator does not need to be equipped with a mirror and the function of driving the DOE to move (such as moving, vibrating, and the like) can be achieved with a conventional actuator such as the one illustrated in FIG. 15, which is a three mode (i.e., center, left, right) horizontal translational actuator. The actuator illustrated in FIG. 15 can move both vertically and horizontally. Other actuators which move vertically or horizontally can also be used and this disclosure is not particularly limited. Thus, when the DOE is mounted on the actuator, it can move with the actuator simultaneously, and compared with the situation where no actuator is used and the DOE is in a static state, dynamic light can be obtained and the direction of light transmission can be changed at the input plane and/or the output plane of DOE as illustrated in FIG. 13 for example. Accordingly, the point cloud projected on user face will be shifted and more reference dots can be obtained for subsequent process, such as capturing an infrared image with the infrared camera of FIG. 4. Thus, it is possible for the infrared camera to acquire a high-resolution depth image by combining a plurality of images of a scene.

In order to expedite the understanding of the disclosure, certain examples will be described.

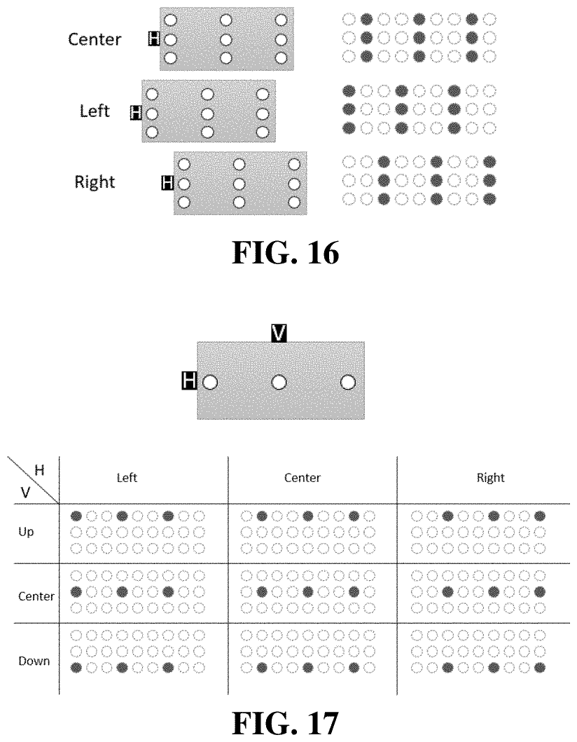

In the following, taking a mask with evenly distributed light through holes as an example of the light filtering section 56 of the disclosure, and the mask is mounted on a three mode horizontal translational actuator, that is, an actuator can move horizontally. In this situation, the actuator can either keep the point cloud in position, or shift it to the left or to the right. As illustrated in FIG. 16, when the actuator stays or moves to the center, infrared dots represented by black solid circles in line “Center” of FIG. 16 can be obtained. When the actuator stays or moves horizontally (“H” in FIG. 5 represents “horizontal”) to the left, infrared dots represented by black solid circles in line “Left” of FIG. 16 can be obtained. Similarly, when the actuator stays or moves horizontally to the right, infrared dots represented by black solid circles in line “Right” of FIG. 16 can be obtained. In the related art without the actuator, only infrared dots represented by black solid circles in line “Center” of FIG. 16 can be obtained. Thus, the configuration provided herein can sample three times of signals for super-resolution 3D mapping.

We can further increase the super-resolution ability of the infrared projector by combining multiple actuators. For example, as illustrated in FIG. 17 where two translational actuators are adopted, that is, when the mask is mounted on two translational actuators, the technical solution provided herein is presented as achieving nine times super resolution 3D mapping results. In FIG. 17, “H” represents “horizontal” and “V” represents “vertical”. It should be noted that, similar effects can also be achieved if a DOE rather than mask is mounted on the actuator or multiple actuators.

For example, here, suppose two actuators are adopted and one actuator moves horizontally while the other actuator moves vertically. Referring to FIG. 17, when one actuator moves upside and the other actuator moves to the left, infrared dots in line 2, column 2 can be obtained; similarly, when one actuator moves downside and the other actuator is at the center, infrared dots in line 4, column 3 can be obtained. Still another example, when one actuator moves downside and the other actuator moves to the right, infrared dots in line 4, column 4 can be obtained. Compares with the situation where no actuator is adopted and only infrared dots in line 3, column 3 is obtained, nine times infrared dots can be obtained.

Instead of shifting the infrared projector evenly, that is, shifting the mask evenly, we can randomly shift the infrared projector or mask to cover different sets of locations as long as we can retrieve the geometry information accurately.

Obviously, the present implementation does not particularly specify the actuator for achieving the infrared projector, and any other configurations may be employed as far as it is appropriate. For example, a multi-mode actuator which can move horizontally and vertically can be used to achieve the same purpose as using two horizontal translational actuators.

For example, it is assumed that we use a point cloud of 30,000 dots and a depth camera of 90 Hz, the present disclosure will yield slightly different results compared with the related art. As can be seen from FIG. 16 and FIG. 17, the point cloud will cover more sets of locations, but each set of locations will only be measured 10 times, while in the related art without any actuator, the point cloud will measure the same set of locations 90 times. With aid of the infrared projector of the disclosure, it is possible to provide more accurate depth information and add randomness to the locations of the point clouds. Fixing the total number of point clouds being emitted, we can sample various sets of locations and superimpose them, and it is possible to increase the safety of biometric applications such as FaceID in terminal devices.

It should be noted that FIG. 16 and FIG. 17 illustrate examples of the infrared points, and the infrared points can be obtained are not limited to the examples.

Besides, in the related art where no actuator is employed, if the scanned surface such as a user face has smaller variation, lower resolution will be obtained; while in this disclosure, even the scanned surface has larger variation, higher resolution can still be obtained.

The foregoing infrared projector is small enough to be integrated into a terminal device such as a smart phone. Based on this and with the understanding that the infrared projector provided herein is applicable more generally to any 3D mapping, scanning, or imaging environments, embodiments of the disclosure further provides an imaging device and a terminal device.

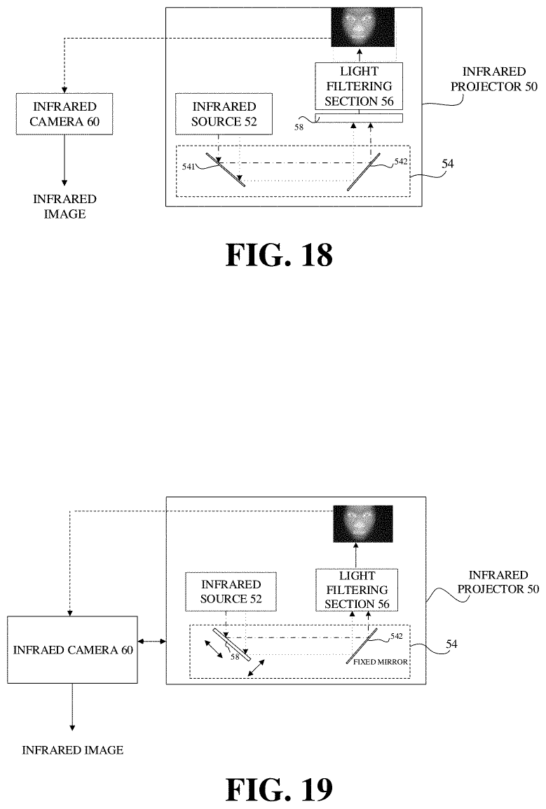

According to embodiments of the disclosure, an imaging device is further provided. As illustrated in FIG. 18 and FIG. 19, the imaging device includes the above-identified infrared projector 50 according to any of the foregoing embodiments of the disclosure, and further includes an infrared camera 60. The infrared projector 50 here can be understood as an “emitter” of the imaging device, which will project point cloud on an object such as a user face, as mentioned before. The imaging device here can use “structured light” technique or TOF technique.

As illustrated in FIG. 18 and FIG. 19, the infrared projector 50 includes an infrared source 52, a light reflective section 54, a light filtering section 56, and at least one driving component 58.

The infrared source 52 is configured to emit infrared lights. The light reflective section 54 is configured to receive and reflect the infrared light emitted from the infrared source 52. The light filtering section 56 is configured receive the infrared light reflected by the light reflective section and let the infrared light pass through to be projected on an object to form point cloud. The at least one driving component 58 is disposed in at least one of the light reflective section 54 and the light filtering section 56 and configured to change a light path from the light reflective section 54 to the object, that is, change exit angles of the infrared light at the light filtering section 56.

The infrared camera 60 is coupled with the infrared projector 50 and is configured to capture an image of the project according to the point cloud formed by the infrared projector 50. For example, the infrared camera 60 is configured to read the dot pattern of the point cloud, capture its infrared image, draw a precise and detailed depth map for user face, and sends the data to a processor of a terminal device for matching for example.

The at least one driving component can include one or more than one actuators mentioned above with reference to the accompany drawings.

In one implementation, the light filtering section 56 is disposed on one of the at least one driving component. For example, the light filtering section 56 which may be embodied as a DOE is mounted on an actuator, as illustrated in FIG. 18.

In another implementation, as illustrated in FIG. 19, the at least one driving component include an actuator equipped with a mirror (that is, micro-mirror actuator, such as the one illustrated in FIG. 11) and is arranged in the light reflective section, the light reflective section further comprises a light reflective component 542. In this case, the actuator 58 is configured to receive and reflect, via the mirror, the infrared light from the infrared source 52, and the reflective component 542 is configured to receive the infrared light from the actuator 58 and reflect the infrared light received from the actuator 58 to the light filtering section 56.

In FIG. 19, the imaging device is structured such that the micro-mirror actuator can receive and reflect the infrared light from the infrared source 52 to the light reflective component 542, however, the structure of FIG. 19 is only for illustrative purpose only and the disclosure is not limited thereto. For example, the position of the micro-mirror actuator 58 and the position of the reflective component 542 such as a mirror can be exchanged, such that the reflective component 542 can be configured to receive and reflect the infrared light from the infrared source 52, and the micro-mirror actuator 58 can be configured to receive the infrared light from the reflective component 542 and reflect, via the mirror, the infrared light received from the reflective component 542 to the light filtering section 56.

Still possibly, the actuator does not necessarily to be integrated with a mirror, in fact, individual components which can be combined to achieve the purpose of shifting the infrared light exiting the light filtering section 56 can be employed. Besides, in FIG. 18 and FIG. 19, only one actuator is illustrated, the disclosure, however, can employ more than one actuator at various locations in the light path of the infrared projector 50 if necessary.

Based on the above, for example, based on the structure of FIG. 18, the at least one driving component comprises a first actuator equipped with a mirror and a second actuator equipped with a second mirror, both the first actuator and the second actuator are disposed in the light reflective section, the first actuator is configured to receive and reflect, via the first mirror, the infrared light from the infrared source 52, and the second actuator is configured to receive the infrared light from the first mirror and reflect, via the second mirror, the infrared light received from the first mirror to the light filtering section 56.

Still another example, based on the structure of FIG. 19, the light filtering section 56 such as a DOE can be mounted on two actuators.

According to still another embodiment of the disclosure, a terminal device is provided. The terminal device can take the form of any kind of devices with 3D scanning, mapping, or imaging functions, such mobile devices, mobile stations, mobile units, machine-to-machine (M2M) devices, wireless units, remote units, user-agent, mobile client, and the like. Examples of the terminal include but are not limited to a mobile communication terminal, a wired/wireless phone, a personal digital assistant (PDA), a smart phone, a vehicle-mounted communication device.

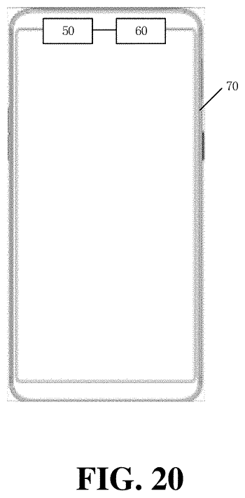

FIG. 20 is a block diagram illustrating the terminal device. As illustrated in FIG. 20, the terminal device includes an infrared projector 50, an infrared camera 60, and a housing 70 configured to accommodate the infrared projector 50 and the infrared camera 60. The infrared projector 50 and the infrared camera 60 can be arranged at the top end of the terminal device. The infrared projector 50 can produce a pattern of about 30,000 infrared dots in front of the terminal device, which illuminate user faces so that they can be photographically captured by the infrared camera 60.

Referring back to FIG. 18 or FIG. 19, the infrared projector 50 includes an infrared source 52, a light reflective section 54, a light filtering section 56, and at least one driving component 58. The infrared source 52 is configured to emit infrared light. The light reflective section 54 is configured to receive and reflect the infrared light emitted from the infrared source 52. The light filtering section 56 is configured receive the infrared light reflected by the light reflective section 54 and let the infrared light pass through to be projected on an object (such as user face) to form point cloud. The at least one driving component is disposed in at least one of the light reflective section 54 and the light filtering section 56 and configured to change a light path from the light reflective section to the object. That is, the driving component can be disposed at the light reflective section 54, disposed at the light filtering section 56, or disposed at both of the light reflective section 54 and the light filtering section 56. The infrared camera 60 is configured to capture an image of the project according to the point cloud.

In one implementation, the at least one driving component comprises an actuator equipped with a mirror (micro-mirror actuator) and is arranged in the light reflective section, the light reflective section further comprises a light reflective component such as a mirror, a reflective plate, or other reflective mechanism.

The micro-mirror actuator can be disposed closer to the infrared source than the reflective component. In this case, the actuator is configured to receive and reflect, via the mirror, the infrared light from the infrared source, and the reflective component is configured to receive the infrared light from the actuator and reflect the infrared light received from the actuator to the light filtering section.

Alternatively, compared with the reflective component, the micro-mirror actuator can be disposed far away from the infrared source is close to the light filtering section. In this case, the reflective component is configured to receive and reflect the infrared light from the infrared source, and the actuator is configured to receive the infrared light from the reflective component and reflect, via the mirror, the infrared light received from the reflective component to the light filtering section.

With aid of the infrared projector, the imaging device, or the terminal device provided herein, much smoother and sharper-edge 3D shape for various applications, such as VR, AR can be obtained. It is also possible to enable better 3D object measurement even with low resolution point clouds or low resolution infrared cameras.

For details not provided herein, reference is made to the foregoing infrared projector and imaging device. Embodiments or features thereof can be combined or substituted with each other without conflicts.

One of ordinary skill in the art can understand that all or part of operations of the infrared projector, the imaging device, and the terminal device can be completed by a computer program to instruct related hardware, and the program can be stored in a non-transitory computer readable storage medium. In this regard, according to embodiments of the disclosure, a non-transitory computer readable storage medium is provided. The non-transitory computer readable storage medium is configured to store at least one computer readable program which, when executed by a computer, cause the computer to carry out all or part of the operations of the method for signal transmission of the disclosure. Examples of the non-transitory computer readable storage medium include but are not limited to read only memory (ROM), random storage memory (RAM), disk or optical disk, and the like.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law

What is claimed is:

1. An infrared projector, comprising:
an infrared source, configured to emit infrared light;
a light reflective section, configured to receive and reflect the infrared light from the infrared source;
a light filtering section, configured to receive the infrared light reflected by the light reflective section; and
at least one driving component, configured to drive at least one of the light reflective section and the light filtering section to move.

2. The infrared projector of claim 1, wherein the light filtering section comprises a first reflective component and a second reflective component, the first reflective component is configured to receive and reflect the infrared light from the infrared source, and the second reflective component is configured to receive the infrared light from the first reflective component and reflect the infrared light received from the first reflective component to the light filtering section.

3. The infrared projector of claim 2, wherein the at least one driving component comprises an actuator, the first reflective component or the second reflective component is disposed on the actuator.

4. The infrared projector of claim 3, wherein the first reflective component and the second reflective component are mirrors, the actuator and the mirror disposed thereon are integrally formed.

5. The infrared projector of claim 2, wherein the at least one driving component comprises two actuators, the first reflective component is disposed on one actuator and the second reflective component is disposed on the other actuator.

6. The infrared projector of claim 5, wherein the first reflective component and the second reflective component are mirrors, the actuator and the mirror disposed thereon are integrally formed.

7. The infrared projector of claim 1, wherein the light reflective section is a mirror disposed on and integrally formed with the at least one driving component.

8. The infrared projector of claim 1, wherein the light filtering section is disposed on the at least one driving component.

9. The infrared projector of claim 6, wherein the light filtering section is a diffractive optical component or an optical mask with evenly distributed small through holes.

10. The infrared projector of claim 1, wherein the light filtering section is configured to project the infrared light received to the outside to form point cloud on a project.

11. An imaging device, comprising:
an infrared projector, comprising:
an infrared source, configured to emit infrared light;
a light reflective section, configured to receive and reflect the infrared light emitted from the infrared source;
a light filtering section, configured receive the infrared light reflected by the light reflective section and let the infrared light pass through to be projected on an object to form point cloud;
at least one driving component, disposed in at least one of the light reflective section and the light filtering section and configured to change a light path from the light reflective section to the object; and
an infrared camera, configured to capture an image of the project according to the point cloud.

12. The imaging device of claim 11, wherein the light filtering section is disposed on one of the at least one driving component.

13. The imaging device of claim 11, wherein the at least one driving component comprises an actuator equipped with a mirror and is arranged in the light reflective section, wherein the light reflective section further comprises a light reflective component.

14. The imaging device of claim 13, wherein the actuator is configured to receive and reflect, via the mirror, the infrared light from the infrared source, and the reflective component is configured to receive the infrared light from the actuator and reflect the infrared light received from the actuator to the light filtering section.

15. The imaging device of claim 13, wherein the reflective component is configured to receive and reflect the infrared light from the infrared source, and the actuator is configured to receive the infrared light from the reflective component and reflect, via the mirror, the infrared light received from the reflective component to the light filtering section.

16. The imaging device of claim 11, wherein the at least one driving component comprises a first actuator equipped with a mirror and a second actuator equipped with a second mirror, both the first actuator and the second actuator are disposed in the light reflective section, the first actuator is configured to receive and reflect, via the first mirror, the infrared light from the infrared source, and the second actuator is configured to receive the infrared light from the first mirror and reflect, via the second mirror, the infrared light received from the first mirror to the light filtering section.

17. A terminal device, comprising:
an infrared projector, comprising:
an infrared source, configured to emit infrared light;
a light reflective section, configured to receive and reflect the infrared light emitted from the infrared source;
a light filtering section, configured to receive the infrared light reflected by the light reflective section and let the infrared light pass through to be projected on an object to form point cloud;
at least one driving component, disposed in at least one of the light reflective section and the light filtering section and configured to change a light path from the light reflective section to the object;
an infrared camera, configured to capture an image of the project according to the point cloud; and
a housing, configured to accommodate the infrared projector and the infrared camera.

18. The imaging device of claim 11, wherein the at least one driving component comprises an actuator equipped with a mirror and is arranged in the light reflective section, wherein the light reflective section further comprises a light reflective component.

19. The imaging device of claim 13, wherein the actuator is configured to receive and reflect, via the mirror, the infrared light from the infrared source, and the reflective component is configured to receive the infrared light from the actuator and reflect the infrared light received from the actuator to the light filtering section.

20. The imaging device of claim 13, wherein the reflective component is configured to receive and reflect the infrared light from the infrared source, and the actuator is configured to receive the infrared light from the reflective component and reflect, via the mirror, the infrared light received from the reflective component to the light filtering section.
